(19) United States
(12) Patent Application Publication
(10) Pub. No.: US 2004/0187820 A1
(43) Pub. Date: Sep. 30, 2004

(54) Duty ratio control device

(75) Inventor: Jiro Kondo, Kariya-city (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pref (JP)

(21) Appl. No.: 10/812,061

(22) Filed: Mar. 30, 2004

(30) Foreign Application Priority Data
Mar. 31, 2003 (JP) 2003-94681

(51) Int. Cl. F01L 1/344; H01F 7/18

(52) U.S. Cl. 123/90.17; 361/152

(57) ABSTRACT

A duty ratio control device varies a ratio between an ON-time and an OFF-time in one cycle to control an amount of electric current supplied to an electric actuator. When a large amount of electric current is supplied to the electric actuator, a time of the cycle becomes longer than a case in which a small amount of electric current is supplied. The time of the cycle is continuously extended as the amount of electric current supplied to the electric actuator increases. The time of the cycle is extended in stages as the amount of electric current supplied to the electric actuator increases. The electric actuator displaces the position of a valve body of a valve in accordance with the amount of supplied electric current.

### CROSS REFERENCE TO RELATED APPLICATION

This application is based upon, claims the benefit of priority of, and incorporates by reference Japanese Patent Application No. 2003-94681 filed Mar. 31, 2003.

### BACKGROUND OF THE INVENTION

1. Field of the invention

The present invention relates to a duty ratio control device for controlling the amount of electric current supplied to an electric actuator by varying the ratio between an ON-time and an OFF-time in one cycle. The invention is applicable to the control of electric actuators that vary the positions of a valve body of a valve.

2. Description of the Related Art

Generally, a device for varying the valve timing of an engine is known. The device continuously varies the position of a spool (valve body) of an oil flow control valve by using the operational control of an electric actuator.

The electric actuator used in the variable valve timing device continuously varies the position of the spool in accordance with the amount of supplied electric current, and the amount of electric current supplied to the electric actuator is controlled by a control device (refer to, for example, Japanese Patent Laid-Open Publication No. Hei 10-280919 (1998)).

Though it is not described in the above patent publication in particular, the amount of electric current supplied to the electric actuator is generally adjusted by duty ratio control. In the duty ratio control, the amount of electric current supplied to the electric actuator is controlled by varying the ratio between an ON-time and an OFF-time in one cycle. To be more specific, when the ratio of ON-time is extended and that of OFF-time is shortened in a single cycle, the amount of electric current supplied to the electric actuator increases. When the ratio of ON-time is shortened and that of OFF-time is extended in the cycle, on the other hand, the amount of electric current supplied to the electric actuator decreases.

The length of the cycle is constant (the PWM frequency is constant) in the duty ratio control. When a small amount of electric current is supplied (in a low-electric current state), since a side force acting between a moving core 15 (hereinafter, refer to FIG. 3 for reference numbers) and a yoke 18 is small, a small frictional force acts between the moving core 15 and a cup guide 22. Therefore, as shown in FIG. 5A, a movable element (for example, a spool 12) easily moves in response to the switching of a power source, and hence searching easily occurs.

When a large amount of electric current is supplied (in a high-electric current state), on the other hand, since the side force acting between the moving core 15 and the yoke 18 is large, a large frictional force acts between the moving core 15 and the cup guide 22. Therefore, as shown in FIG. 5B, since the movable element is hard to move in response to the switching of the power source, a dynamic frictional state (the vibrational state of the movable element) cannot be maintained, and hence there is a problem such that the response of the movable element becomes worse.

### SUMMARY OF THE INVENTION

The present invention focuses on the fact that a dither amplitude correlates with a PWM frequency. An object of the present invention is to provide a duty ratio control device that prevents the occurrence of searching for a movable element caused by too small of a frictional force acting on a moving core in a low-electric current state, and the deterioration of a response caused by too large of a frictional force acting on the moving core in a high-electric current state.

In a duty ratio control device, the time of one cycle becomes long when a large amount of electric current is supplied to an electric actuator, as compared with a case where a small amount of electric current is supplied thereto. In other words, the time of one cycle is short (the PWM frequency is high) when a small amount of electric current is supplied to the electric actuator. To the contrary, the time of one cycle is long (the PWM frequency is low) when a large amount of electric current is supplied to the electric actuator.

As described above, since the time of one cycle is short when a small amount of electric current is supplied to the electric actuator, a pulsing electromagnetic force caused by an ON-state and then OFF-state current is suppressed. As a result, an increase in dither amplitude is suppressed, so that the searching of a movable element is prevented from occurring.

On the other hand, since the time of one cycle is long when a large amount of electric current is supplied to the electric actuator, the pulsing electromagnetic force caused by the ON-state and OFF-state of the current is increased. As a result, a dynamic frictional state can be maintained, so that the response of the movable element is prevented from worseningned.

In the duty ratio control device of another aspect, the time of one cycle is continuously extended as the amount of electric current supplied to the electric actuator increases. According to a structure such as this, the time of one cycle becomes short as the amount of electric current supplied to the electric actuator decreases. Even if the amount of supplied electric current is small, the pulsing electromagnetic force caused by the ON-state and OFF-state of the current is suppressed, and hence an increase in dither amplitude is suppressed. As a result, the searching of the movable element is prevented from occurring.

On the other hand, since the time of one cycle becomes long as the amount of electric current supplied to the electric actuator increases, even if the amount of supplied electric current is large, the pulsing electromagnetic force caused by the ON-state and the OFF-state of the current is increased, and hence a dynamic frictional state is maintained. As a result, the response of the movable element is prevented from worsening.

In the duty ratio control device of another aspect, the time of one cycle is extended in stages as the amount of electric current supplied to the electric actuator increases. Also in the structure like this, since the time of one cycle becomes short when a small amount of electric current is supplied to the electric actuator, the pulsing electromagnetic force caused by the ON-state and the OFF-state of the current is suppressed, and hence an increase in dither amplitude is suppressed. As a result, the searching of the movable element is prevented from occurring.

On the other hand, the time of one cycle becomes long when a large amount of electric current is supplied to the electric actuator, and hence the pulsing electromagnetic force caused by the ON-state and the OFF-state current is increased. As a result, a dynamic frictional state is maintained, so that the response of the movable element is prevented from worsening.

In the duty ratio control device of another aspect, the electric actuator displaces the position of a valve body (the movable element) of a valve in accordance with the amount of supplied electric current. According to a structure like this, since the time of one cycle is short when a small amount of electric current is supplied to the electric actuator, the pulsing electromagnetic force caused by the ON-state and the OFF-state of the current is suppressed, and hence an increase in dither amplitude is suppressed. As a result, the searching of the valve body is prevented from occurring.

On the other hand, the time of one cycle is long when a large amount of electric current is supplied to the electric actuator, and hence a pulsing electromagnetic force caused by the ON-state and the OFF-state current is increased. As a result, a dynamic frictional state is maintained, so that the response of the valve body is prevented from worsening. The duty ratio control device that adopts these means is used for controlling an oil flow control valve, which is combined with a variable cam timing mechanism in order to relatively supply/release oil pressure generated by an oil pressure source to/from an advance angle side chamber and a retarded angle side chamber during the operation of an internal combustion engine.

By applying the embodiment of the present invention to the control of the oil flow control valve which controls the oil pressure of the variable cam timing mechanism, the time of one cycle becomes short when a small amount of electric current is supplied to the electric actuator (for example, in retarded angle control of a cam shaft). Thus, the pulsing electromagnetic force caused by the ON-state and the OFF-state current is suppressed, and an increase in the dither amplitude is suppressed. As a result, the searching of the oil flow control valve is prevented from occurring.

When a large amount of electric current is supplied to the electric actuator (for example, in advance angle control of the cam shaft), on the other hand, the time of one cycle becomes long, and hence the pulsing electromagnetic force caused by the ON-state and the OFF-state of the current becomes large. As a result, a dynamic frictional state is maintained, so that the response of the oil flow control valve is prevented from worsening.

Namely, with the use of the embodiment of the present invention for controlling the oil flow control valve, which controls the oil pressure of the variable cam timing mechanism, it is possible to operate the oil flow control valve with a high degree of response and a high degree of stability in a wide range from retarded angle control to advance angle control. Therefore, it is possible to increase the reliability of the operation of the variable valve timing device (VVT), which comprises the variable cam timing mechanism (VCT) and a hydraulic circuit using the oil flow control valve.

Further areas of applicability of the present invention will become apparent from the detailed description provided hereinafter. It should be understood that the detailed description and specific examples, while indicating the preferred embodiment of the invention, are intended for purposes of. illustration only and are not intended to limit the scope of the invention.

### BRIEF DESCRIPTION OF THE DRAWINGS

The present invention will become more fully understood from the detailed description and the accompanying drawings, wherein:

FIG. 1A is a graph of the relationship between a low amount of supplied electric current and the length of one cycle according to the prior art;

FIG. 1B is a graph of the relationship between a high amount of supplied electric current and the length of one cycle according to the prior art;

FIG. 1C is a graph of the relationship between a low amount of supplied electric current and the length of one cycle according to the embodiment of the invention;

FIG. 1D is a graph of the relationship between a high amount of supplied electric current and the length of one cycle according to the embodiment of the invention;

FIG. 2 is a schematic view of a variable valve timing device according to the embodiment of the invention;

FIG. 3 is a cross-sectional view of an oil flow control valve in an axial direction according to the embodiment of the invention;

FIG. 4 is a block diagram of an ECU according to the embodiment of the invention;

FIG. 5A is a graph showing the relationship between a low amount of supplied electric current and the length of one cycle according to the prior art; and

FIG. 5B is a graph showing the relationship between a high amount of supplied electric current and the length of one cycle according to the prior art.

### DETAILED DESCRIPTION OF THE PREFERRED EMBODIMENTS

The following description of the preferred embodiment, its examples and modifications is merely exemplary in nature and is in no way intended to limit the invention, its application, or uses.

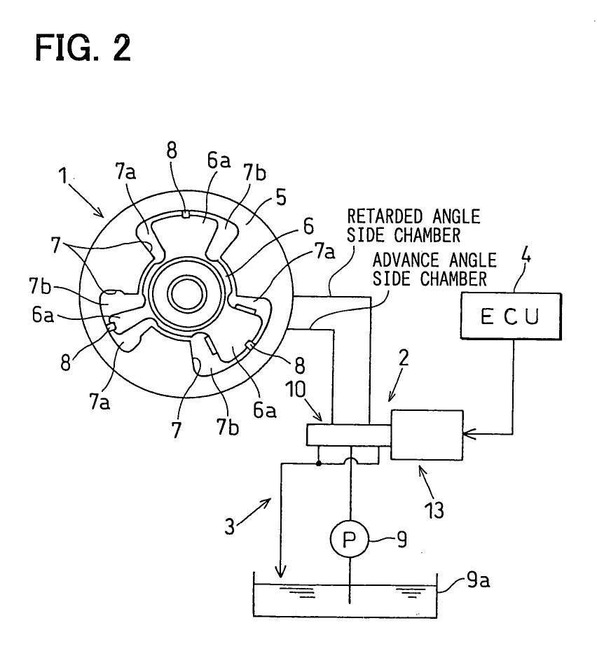

The variable valve timing device according to this embodiment (FIG. 2), which is attached to a cam shaft (any of the cam shafts for an intake valve, an exhaust valve, and dual- purpose intake and exhaust) of an internal combustion engine (hereinafter called engine), can continuously vary the opening and closing timing of a valve.

The variable valve timing device (VVT) has a variable cam timing mechanism 1 (VCT), a hydraulic circuit 3 having an oil flow control valve 2, and an ECU 4 (Engine Control Unit: corresponding to a duty ratio control device) for controlling the oil flow control valve 2.

The variable cam timing mechanism 1 has a shoe housing 5 (corresponding to a rotary driving element) which rotates in synchronization with a crank shaft of the engine, and a vane rotor 6 (corresponding to a rotary driven element) which is relatively rotatable with respect to the shoe housing 5 and rotates integrally with the cam shaft. The variable cam timing mechanism 1 relatively rotates the vane rotor 6 with respect to the shoe housing 5 by use of a hydraulic actuator structured inside the shoe housing 5, in order to vary the cam shaft on an advance angle side or a retarded angle side.

The shoe housing 5, secured to a sprocket with bolts or the like, rotates integrally with the sprocket. The sprocket is rotated by the crank shaft of the engine through a timing belt, a timing chain, or the like. Inside the shoe housing 5, as shown in FIG. 2, a plurality of (three in this embodiment) recessed portions 7 approximately having the shape of a sector are formed. The shoe housing 5 rotates in a clockwise direction in FIG. 2, and this rotational direction refers to an advance angle direction.

On the other hand, the vane rotor 6, which is positioned at an end of the cam shaft by a positioning pin or the like and is secured to the end of the cam shaft with bolts or the like, rotates integrally with the cam shaft. The vane rotor 6 is provided with vanes 6a each of which partitions the inside of the recessed portion 7 of the shoe housing 5 into an advance angle side chamber 7a and a retarded angle side chamber 7b. The vane rotor 6 is rotatably provided within a predetermined angle with respect to the shoe housing 5.

The advance angle side chamber 7a, formed in the recessed portion 7 on the side of the reverse rotational direction of the vane 6a, is a hydraulic chamber for driving the vane 6a on the advance angle side by use of oil pressure. The retarded angle side chamber 7b, on the other hand, is a hydraulic chamber for driving the vane 6a on the retarded angle side by use of oil pressure. Seal members 8 and the like maintain the hermetically sealed status of each chamber 7a, 7b.

The hydraulic circuit 3 is means for supplying/discharging oil to/from the advance angle side chambers 7a and the retarded angle side chambers 7b, to relatively rotate the vane rotor 6 with respect to the shoe housing 5 by generating a difference in oil pressure between the advance angle side chambers 7a and the retarded angle side chambers 7b. The hydraulic circuit 3 is provided with an oil pump 9 driven by the engine crank shaft or the like, and the oil flow control valve 2, which supplies the advance angle side chambers 7a or the retarded angle side chambers 7b with oil pumped by the oil pump 9, is capable of switching between the advance angle side chambers 7a and the retarded angle side chambers 7b.

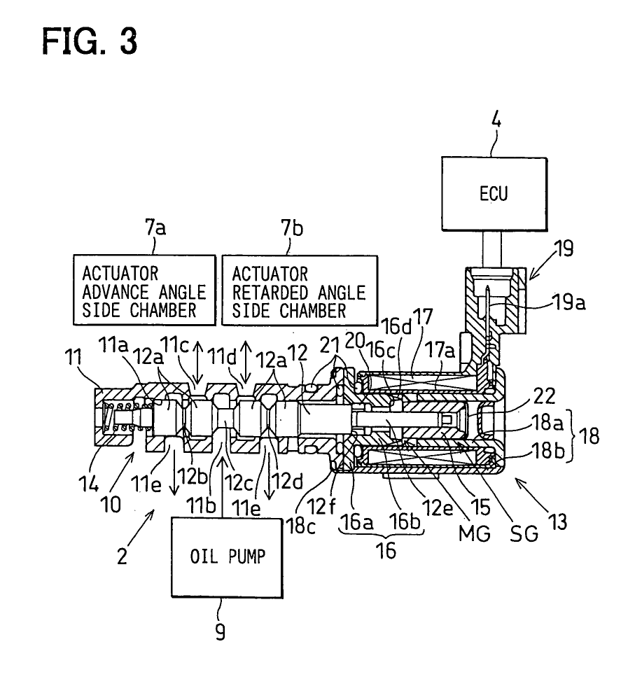

Referring to FIG. 3 the oil flow control valve 2 will be explained.

The oil flow control valve 2 comprises a spool valve 10 having a sleeve 11 and a spool 12, and an electromagnetic actuator 13 for driving the spool 12 in an axial direction.

A plurality of input-output ports is formed in the sleeve 11, which approximately takes the shape of a cylinder. To be more specific, in the sleeve 11 according to this embodiment, a through hole 11a for slidably holding the spool 12 in the axial direction, an oil pressure supply port 11b connected to an oil exhaust port of the oil pump 9, an advance angle side chamber connection port 11c connected to the advance angle side chamber 7a, a retarded angle side chamber connection port 11d connected to the retarded angle side chamber 7b, and a drain port 11e for returning oil to an oil pan 9a are formed.

The oil pressure supply port 11b, the advance angle side chamber connection port 11c, and the retarded angle side chamber connection port 11d are formed in the sidewall of the sleeve 11, in order of the drain port 11e, the advance angle side chamber connection port 11c, the oil pressure supply port 11b, the retarded angle side chamber connection port 11d, and the drain port 11e from the left side (the opposite side of the coil) to the right side (the side of the coil) of FIG. 3.

The spool 12 is provided with four large-diameter portions 12a (lands) for blocking the ports. The outside diameter of the large diameter portions 12a almost equal the inside diameter of the sleeve 11 (the diameter of the through hole 11a). A small-diameter portion for draining the advance angle side chambers 12b, a small-diameter portion for supplying oil pressure 12c, and a small-diameter portion for draining the retarded angle side chambers 12d are formed between the large-diameter portions 12a, to change the connection state of the input-output ports (11b to lie) in accordance with the position of the spool 12 in the axial direction.

The small-diameter portion 12b that drains the advance angle side chambers releases oil pressure from the advance angle side chambers 7a when oil pressure is supplied to the retarded angle side chambers 7b. The small-diameter portion 12c for supplying oil pressure supplies oil pressure to one of the advance angle side chambers 7a and the retarded angle side chambers 7b. The small-diameter portion 12d for draining the retarded angle side chambers releases oil pressure from the retarded angle side chambers 7b when oil pressure is supplied to the advance angle side chambers 7a.

The spool 12 is integrally provided with a small-diameter shaft 12e that extends inside a coil 17. The shaft 12e is coupled to a moving core 15 by press-fitting or the like. A spring 14, as a biasing means, for biasing the spool 12 toward the coil 17 (the right side of FIG. 3), is disposed on the opposite side (the left side of FIG. 3) of the spool 12 as the coil 17.

The electromagnetic actuator 13, which corresponds to an electric actuator, is provided with the moving core 15, a stator 16, the coil 17, a yoke 18, and a connector 19. The moving core 15, which is made of a magnetic metal such as iron, is magnetically attracted by the stator 16 and is fixed on the end of the above shaft 12e by press-fitting or the like. Therefore, the moving core 15 moves integrally with the spool 12 in the axial direction. The stator 16, which is made of a magnetic metal such as iron, has a disk portion 16a sandwiched between the sleeve 11 and the coil 17, and a cylindrical portion 16b for leading the magnetic flux of the disk portion 16a to the vicinity of the moving core 15. A main gap MG (magnetic attraction gap) is formed between the moving core 15 and the cylindrical portion 16b.

A recessed portion 16c is formed in the end of the cylindrical portion 16b so that the end of the moving core 15 is inserted without making contact with the stator 16. Since the moving core 15 enters the recessed portion 16c, a part of the moving core 15 intersects with a part of the stator 16 in the axial direction when the moving core 15 is attracted to the end of the stator 16. A taper 16d is formed on the end of the cylindrical portion 16b so that it provides a characteristic such that a magnetic attraction force does not change in response to the amount of a stroke of the moving core 15.

The coil 17 has an enamel wire wound numerous times around a resin bobbin 17a, which is a magnetic force generation means, which generates a magnetic force when being energized to magnetically attract the moving core 15 to the stator 16.

The yoke 18 made of magnetic metal (for example, iron) comprises an inner cylindrical portion 18a for covering the periphery of the moving core 15, and an outer cylindrical portion 18b for covering the periphery of the coil 17. The yoke 18 is coupled to the sleeve 11 by swaging or forming a claw portion 18c formed on the left side of FIG. 3. The inner cylindrical portion 18a transmits magnetic flux to the moving core 15, and a side gap SG (magnetic flux passing gap) is formed between the moving core 15 and the inner cylindrical portion 18a.

The connector 19 is a connection means for electrically connecting the electromagnetic actuator 13 to the ECU 4 through connecting wires. Terminals 19a connected to both ends of the coil 17 are disposed in the connector 19. When the coil 17 is not energized, the spool 12 and the moving core 15 are displaced by the biasing force of the spring 14 and stopped on the side of the coil (the right side of FIG. 3) in the oil flow control valve 2.

In this stopped state, the maximum gap of the main gap MG is determined, and the spool 12 is aligned with respect to the sleeve 11. In the oil flow control valve 2 according to this embodiment, the contact between a ring-shaped collar 20 attached to the inside of the stator 16 and a step 12f formed in the spool 12 composes a stopper when the spool 12 and the moving core 15 are displaced on the side of the coil (when the coil 17 is not energized). In FIG. 3, O-rings 21 provide sealing and a cup guide 22 prevents oil from leaking.

The ECU 4 linearly controls the position of the spool 12 in the axial direction by controlling the amount of electric current supplied to the coil 17 of the electromagnetic actuator 13, and makes the advance angle side chambers 7a and the retarded angle side chambers 7b generate operating oil pressure in response to the operational state of the engine in order to control the spark advance phase of the cam shaft. Details of the ECU 4 will be described later.

When the ECU 4 advances the cam shaft in accordance with the drive state of a vehicle, the ECU 4 increases the amount of electric current supplied to the coil 17. Then, a magnetic force generated by the coil 17 increases, and hence the moving core 15 and the spool 12 move to the opposite side of the coil (the left side of FIG. 3: the advance angle side). The connection ratio between the oil pressure supply port 11b and the advance angle side chamber connection port 11c increases, and the connection ratio between the retarded angle side chamber connection port 11d and the drain port 11e increases. As a result, since oil pressure increases in the advance angle side chambers 7a and decreases in the retarded angle side chambers 7b, the vane rotor 6 is relatively displaced on the advance angle side with respect to the shoe housing 5, and hence the cam shaft advances.

When the ECU 4 delays the cam shaft in accordance with the drive state of the vehicle, on the other hand, the ECU 4 decreases the amount of electric current supplied to the coil 17. Then, magnetic force generated by the coil 17 decreases, and hence the moving core 15 and the spool 12 move to the side of the coil (the right side of FIG. 3: the retarded angle side). The connection ratio between the oil pressure supply port 11b and the retarded angle side chamber connection port 11d increases, and the connection ratio between the advance angle side chamber connection port 11c and the drain port 11e increases. As a result, since oil pressure increases in the retarded angle side chambers 7b and decreases in the advance angle side chambers 7a, the vane rotor 6 is relatively displaced on the retarded angle side with respect to the shoe housing 5, and hence the cam shaft delays.

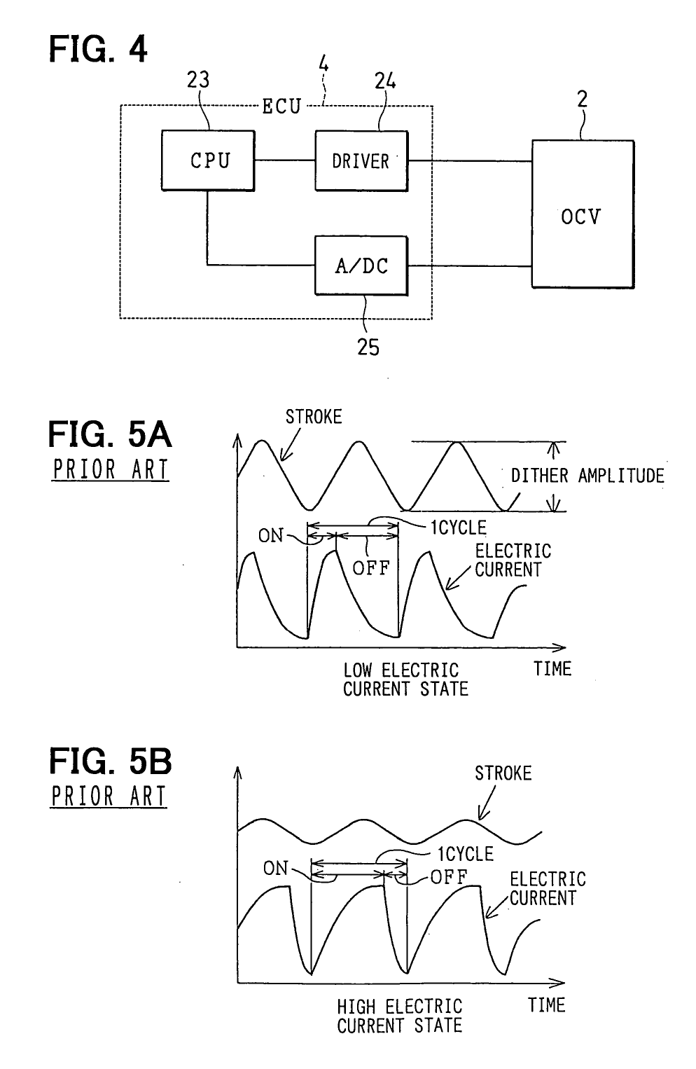

Referring to FIG. 4, the ECU 4 has a CPU 23, a driver 24 (EDU), an A/D converter 25, and the like. The CPU 23 composes a main portion of the duty ratio control device which carries out duty ratio control of the amount of electric current supplied to the coil 17 of the electromagnetic actuator 13 (hereinafter called the amount of supplied electric current). The ECU 4 actually includes a memory device (a RAM, a ROM or the like) and the like, in addition to the CPU 23. The duty ratio control refers to variably controlling the amount of supplied electric current by varying the ratio between the ON-time and the OFF-time in one cycle in a control frequency (a PWM frequency).

The CPU 23 calculates the amount of supplied electric current in accordance with the drive state of the engine such as a crank angle, engine speed, the degree of opening of an accelerator, and the like detected by various sensors (not shown), and determines a duty ratio (the ratio between ON-time and OFF-time in one cycle) corresponding to the obtained amount of supplied electric current. The driver 24 carries out the ON-OFF control of the coil 17 of the electromagnetic actuator 13 on the basis of a control signal (an order signal) of the duty ratio obtained by the CPU 23.

The ECU 4, according to this embodiment, monitors the amount of electric current supplied to the coil 17 by a resistor (not shown) for detecting electric current. The A/D converter 25 is a means for reading the amount of electric current, which is detected by the resistor for detecting electric current, to the CPU 23.

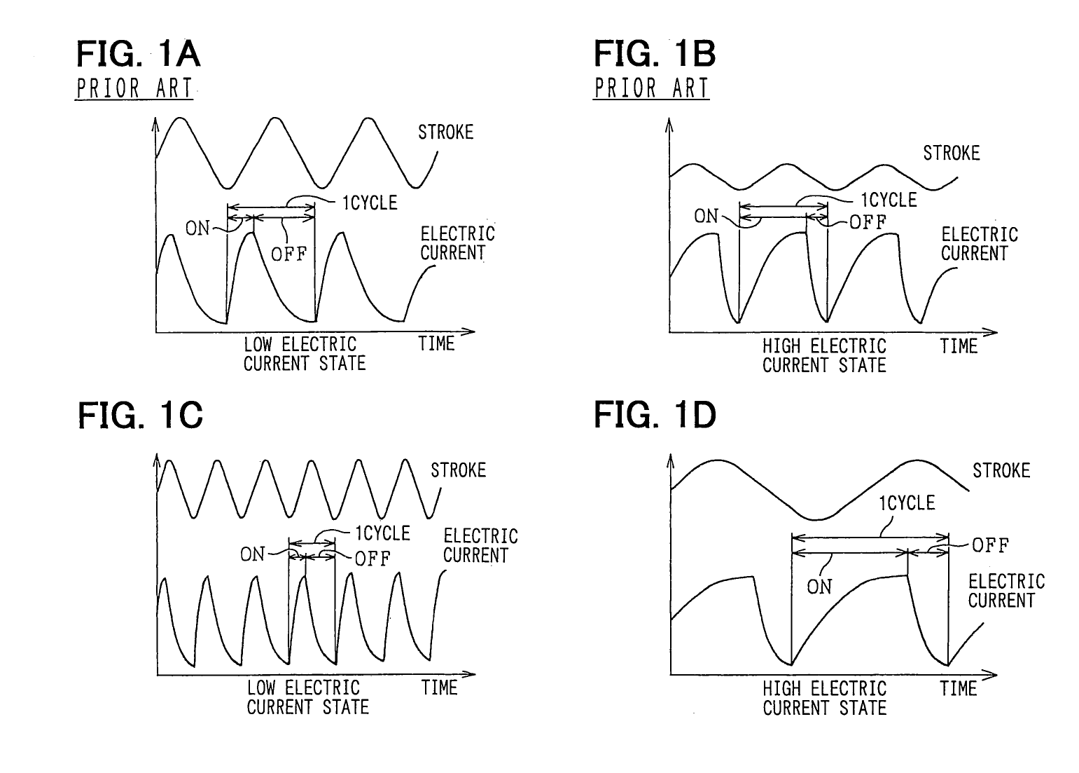

In the prior art, as described in the Description of the Related Art, the length of one cycle is constant (the PWM frequency is constant) in the duty ratio control. When a small amount of electric current is supplied (in a low-electric current state), a side force acting between the moving core 15 and the yoke 18 is small so that a frictional force acting between the moving core 15 and the cup guide 22 is small. Therefore, since the spool 12 (corresponding to a valve body) easily moves in response to the switching of a power source, as shown in FIG. 1A, a dither amplitude increases as the amount of supplied electric current decreases so that the searching easily occurs in the spool 12 to which the moving core 15 is secured.

When a large amount of electric current is supplied (in a high-electric current state), on the other hand, since a side force acting between the moving core 15 and the yoke 18 is large, frictional force acting between the moving core 15 and the cup guide 22 is large. Therefore, since the spool 12 is hard to move in response to the switching of the power source, as shown in FIG. 1B, a dither amplitude becomes too small as the amount of supplied electric current increases. The dynamic frictional state of the spool 12 cannot be maintained, and hence there is the problem of the response of the spool 12 becoming worse.

For this reason, the CPU 23 according to this embodiment shortens the time of one cycle (increases the PWM frequency) when the amount of electric current supplied to the electromagnetic actuator 13 is small, and continuously extends the time of one cycle (decreases the PWM frequency) as the amount of supplied electric current increases.

According to the structure like this, since the time of one cycle becomes short as the amount of electric current supplied to the electromagnetic actuator 13 decreases, the displacement of the spool 12 (valve body) is maintained almost at a constant quantity. Therefore, even if the amount of supplied electric current is small, as shown in FIG. 1C, searching does not occur in the spool 12.

On the other hand, since the time of one cycle becomes long as the amount of electric current supplied to the electromagnetic actuator 13 increases, the displacement of the spool 12 (valve body) is kept almost at a constant quantity. Therefore, even if the amount of supplied electric current is large, as shown in FIG. 1D, it is possible to maintain the dynamic frictional state of the spool 12. In other words, the response of the spool 12 does not become worse even if a large amount of electric current is supplied.

Applying the present invention to the control of the oil flow control valve 2 in the variable valve timing device, as described above, it is possible to maintain the high response and high stability of the oil flow control valve 2 in a wide range, from retarded angle control to advance angle control. Namely, applying the present invention makes it possible to maintain the response and stability of the oil flow control valve 2, so that the reliability of the operation of the variable valve timing device is increased.

### MODIFICATION EXAMPLES

In the foregoing embodiment, the length of time of one cycle (the PWM frequency) is continuously varied in response to a variation in the amount of supplied electric current, but it may be switched in stages (two or more stages). The variable cam timing mechanism 1 described in the foregoing embodiment is just an example for explaining the embodiment. Another structure is applicable as long as the hydraulic actuator contained in the variable cam timing mechanism 1 carries out advance angle adjustment.

In the foregoing embodiment, for example, three recessed portions 7 are formed in the shoe housing 5, and the three vanes 6a are provided in the outer periphery of the vane rotor 6. The number of the recessed portions 7 and that of the vane rotors 6a are not limited to three, as long as there are structurally one or more. The shoe housing 5 rotates in synchronization with the crank shaft, and the vane rotors 6 integrally rotate with the cam shaft in the foregoing embodiment. The vane rotors 6, however, may rotate in synchronization with the crank shaft, and the shoe housing 5 may integrally rotate with the cam shaft.

In the foregoing embodiment, the spool 12 has the large-diameter portion 12a and the small-diameter portions 12b to 12d. The structure of the spool 12, however, is not limited to such, and a spool 12 in the shape of, for example, a cylinder may be used instead. Furthermore, openings are formed in the sidewall of the sleeve 11 to provide the input-output ports (the oil pressure supply port 11b, the advance angle side chamber connection port 11c, the retarded angle side chamber connection port 11d and the like in the embodiment). The structure of the sleeve 11, however, is not limited to such, and, for example, a plurality of input-output ports may be provided by, for example, forming through holes in the direction of a diameter of the sleeve 11.

The structure of the electromagnetic actuator 13, described in the foregoing embodiment, is just an example for explaining the embodiment, but other structures are applicable. The moving core 15, for example, may be disposed about the outside of the coil 17 in the axial direction. Furthermore, the spool 12 is displaced on the opposite side of the coil when the coil 17 is energized. The spool 12, however, may be displaced on the side of the coil when the coil 17 is energized.

The present invention is applied to the control of the oil flow control valve 2 which is combined with the variable cam timing mechanism 1 in the foregoing embodiment, but it is applicable to all types of oil flow control valves 2 that switch between on and off states of the flow of oil and the flow direction thereof.

The present invention is not limited to control of the oil flow control valve 2, but it is applicable to the control of the electromagnetic actuator 13 for driving a valve body of a valve. Furthermore, the present invention is not limited to the control of the electromagnetic actuator 13 for driving the valve body, but it is applicable to the control of the electromagnetic actuator 13 for driving a movable element other than the valve body.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A duty ratio control device for varying a ratio between an ON-time and an OFF-time in one cycle to control an amount of electric current supplied to an electric actuator, wherein
when a large amount of electric current is supplied to said electric actuator, a time of said cycle becomes longer than a case in which a small amount of electric current is supplied thereto.

2. The duty ratio control device according to claim 1, wherein
time of said cycle is continuously extended, as the amount of electric current supplied to said electric actuator increases.

3. The duty ratio control device according to claim 1, wherein
time of said cycle is extended in stages, as the amount of electric current supplied to said electric actuator increases.

4. The duty ratio control device according to claim 1, wherein
said electric actuator displaces the position of a valve body of a valve in accordance with the amount of supplied electric current.

5. The duty ratio control device according to claim 4, wherein
said valve comprising:
a rotary driving element rotationally driven in synchronization with a crank shaft of an internal combustion engine; and
a rotary driven element relatively rotatable with respect to said rotary driving element and rotating integrally with a cam shaft of said internal combustion engine; wherein
said valve is combined with a variable cam timing mechanism, said variable cam timing mechanism supplying oil pressure to an advance angle side chamber formed between said rotary driving element and said rotary driven element, in order to displace said cam shaft with said rotary driven element on an advance angle side with respect to said rotary driving element, and supplying oil pressure to a retarded angle side chamber formed between said rotary driving element and said rotary driven element, in order to displace said cam shaft with said rotary driven element on a retarded angle side with respect to said rotary driving element, and
said valve is an oil flow control valve for relatively supplying/ejecting oil pressure occurring in an oil pressure source to/from said advance angle side chamber and said retarded angle side chamber during the operation of said internal combustion engine.

6. The duty ratio control device according to claim 1, the actuator further comprising:
a moveable portion; and
a yoke, wherein the yoke accommodates the moveable portion so the moveable portion can reciprocate, said yoke capable of transmitting a magnetic flux to the movable portion.

7. An apparatus comprising:
a duty ratio control device;
an electric actuator, wherein said duty ratio control device varies a ratio between an ON-time and an OFF-time in one cycle to control an amount of electric current supplied to said electric actuator such that when a large amount of electric current is supplied to said electric actuator, a time of said cycle becomes longer than a case in which a small amount of electric current is supplied to said actuator; and
a valve, wherein said electric actuator displaces a position of a valve body of said valve in accordance with the amount of electric current supplied.

8. The apparatus of claim 7, said valve further comprising:
a rotary driving element rotationally driven in synchronization with a crank shaft of an internal combustion engine; and
a rotary driven element relatively rotatable with respect to said rotary driving element and rotating integrally with a cam shaft of said internal combustion engine; wherein
said valve is combined with a variable cam timing mechanism, said variable cam timing mechanism supplying oil pressure to an advance angle side chamber formed between said rotary driving element and said rotary driven element, in order to displace said cam shaft with said rotary driven element on an advance angle side with respect to said rotary driving element, and supplying oil pressure to a retarded angle side chamber formed between said rotary driving element and said rotary driven element, in order to displace said cam shaft with said rotary driven element on a retarded angle side with respect to said rotary driving element, and
said valve is an oil flow control valve for relatively supplying/ejecting oil pressure occurring in an oil pressure source to/from said advance angle side chamber and said retarded angle side chamber during the operation of said internal combustion engine.
